(19) United States
(12) Patent Application Publication
(10) Pub. No.: US 2012/0085500 A1
(43) Pub. Date: Apr. 12, 2012

(54) Methods Of Applying Protective Films

(75) Inventors: Joseph P. Knapke, Lima, OH (US); Maria Cohinta Bocanegra Flores, Troy, OH (US); Cynthia Ann Miller, Wapakoneta, OH (US); Frank J. Catanzarite, Sidney, OH (US)

(73) Assignee: AMERICAN TRIM, L.L.C., Lima, OH (US)

(21) Appl. No.: 13/061,956

(22) PCT Filed: Jun. 24, 2010
(86) PCT No.: PCT/US10/39803

§ 371 Date: Mar. 25, 2011

Related U.S. Application Data
(60) Provisional application No. 61/220,347, filed on Jun. 25, 2009.

(51) Int. Cl. B32B 38/10; B05D 3/02; B05D 5/00

(52) U.S. Cl. 156/701; 427/510

(57) ABSTRACT

Methods for applying protective polymeric films on metal substrates are described. The methods involve depositing a liquid curable resin on a substrate in a particular manner and then curing the resin to form the protective film. The films can be readily peeled off from the substrates and are environmentally friendly.

### CROSS REFERENCES TO RELATED APPLICATIONS

The present application claims priority upon U.S. provisional application Ser. No. 61/220,347 filed Jun. 25, 2009.

### FIELD OF INVENTION

The present invention relates to methods of applying protective films to a variety of surfaces, such as panels and enclosures in consumer appliances. The protective films can be readily applied and removed from the surfaces of interest, and do not present disposal or recycling issues.

### BACKGROUND OF THE INVENTION

It is well known to protect housings and enclosures of appliances and other consumer goods by use of a plastic layer applied onto outer surfaces of the enclosure. Generally, panels used in the assembly receive a protective plastic layer onto one or more of their faces prior to assembly onto one or more of their faces prior to assembly into the enclosure or appliance. The protective layer guards against scratches or otherwise result from contact with other panels or objects in the assembly environment. As will be appreciated, reworking, repainting, and/or refinishing a panel surface to remove such scratches is costly and if not detected prior to product shipment can lead to the perception of poor product quality by consumers.

It is paramount that upon removal, protective films leave the underlying surface unblemished, and without any residue. It is also important that such films not rip or tear during removal as that requires further efforts and time to fully remove remnant portions of the film. Additionally, ripping or tearing of such films when experienced by consumers, undoubtedly leads to increased frustration. These and other concerns dictate that protective films exhibit a particular combination of strength and release characteristics. Although certain known films possess a suitable combination of such properties, it would be desirable to provide a film with improved properties in this regard.

Protective films are known which contain polyvinyl chloride (PVC). The detrimental health effects of PVC and its precursors chlorine and cancer-causing vinyl chloride monomer, have been extensively reported. Furthermore, after such protective films are removed from panels and enclosures, they present additional issues related to their disposal or recycling due to their PVC content. Accordingly, it would be desirable to provide a protective film that was free of PVC to avoid these and other issues.

Phthalates are chemical compounds and have been used for many years as plasticizers to make plastics softer and improve their flexibility. Numerous protective films employ phthalates for this purpose. However, it has recently been discovered that certain phthalates may pose health issues. Although the potential for health hazards is not fully known, it would be desirable to provide a protective film that was free of phthalates to avoid these and other issues.

### SUMMARY OF THE INVENTION

The difficulties and drawbacks associated with previous protective films and methods of protecting substrates by use of such films are overcome in the present invention methods. The present invention methods provide a film that is flexible, strong, and provides excellent protection to an underlying surface. The film can be easily removed from the surface by simply peeling the film therefrom. Moreover, the films are environmentally friendly.

In a first aspect, the present invention provides a method for forming a flexible, peelable, protective solid film on a surface of a substrate. The method comprises a step of coating at least a portion of the surface of the substrate with a liquid curable resin composition. The method also comprises a step of exposing the coated portion of the substrate to an amount of ultraviolet radiation sufficient to cure the liquid composition and thereby form the flexible, peelable, protective solid film on the portion of the surface of the substrate.

In another aspect, the present invention provides a method of protecting a surface of a substrate. The method comprises coating at least a portion of the surface of the substrate with a liquid curable resin composition. The method also comprises exposing the coated portion of the substrate to an amount of ultraviolet radiation sufficient to cure the liquid composition and thereby form a flexible, protective solid film on the portion of the surface of the substrate. And, the method additionally comprises peeling the flexible, protective solid film from the portion of the surface of the substrate to thereby easily remove the film therefrom.

As will be realized, the invention is capable of other and different embodiments and its several details are capable of modifications in various respects, all without departing from the invention. Accordingly, the drawings and description are to be regarded as illustrative and not restrictive.

### BRIEF DESCRIPTION OF THE DRAWINGS

FIG. 1 is a schematic illustration of a first representative system for forming protective coatings on substrate surfaces, in accordance with a preferred embodiment of the present invention.

FIG. 2 is another schematic illustration of the first representative system for forming protective coatings on substrate surfaces, depicting initial positioning of a panel.

FIG. 3 is another schematic illustration of the first representative system for forming protective coatings on substrate surfaces, illustrating introducing the panel into a screen printer.

FIG. 4 is another schematic illustration of the first representative system for forming protective coatings on substrate surfaces, illustrating application of a liquid composition onto a face of the panel.

FIG. 5 is another schematic illustration of the first representative system for forming protective coatings on substrate surfaces, illustrating a coated panel prior to curing of the composition.

FIG. 6 is another schematic illustration of the first representative system for forming protective coatings on substrate surfaces, depicting curing of the coated panel.

FIG. 7 is another schematic illustration of the first representative system for forming protective coatings on substrate surfaces, illustrating the panel after curing of the composition thereby forming a protective film.

FIG. 8 is another schematic illustration of the first representative system for forming protective coatings on substrate surfaces, depicting subsequent transport or storage of the protected panels.

FIG. 9 is a schematic illustration of a second representative system for forming protective coatings on substrate surfaces, in accordance with a preferred embodiment of the present invention.

FIG. 10 is another schematic illustration of the second representative system for forming protective coatings on substrate surfaces, illustrating selection of a panel to be protected.

FIG. 11 is another schematic illustration of the second representative system for forming protective coatings on substrate surfaces, illustrating positioning of the panel prior to coating.

FIG. 12 is another schematic illustration of the second representative system for forming protective coatings on substrate surfaces, illustrating screen printing a liquid composition on the panel.

FIG. 13 is another schematic illustration of the second representative system for forming protective coatings on substrate surfaces, depicting the coated panel prior to curing.

FIG. 14 is another schematic illustration of the second representative system for forming protective coatings on substrate surfaces, illustrating the panel and coating undergoing curing.

FIG. 15 is another schematic illustration of the second representative system for forming protective coatings on substrate surfaces, illustrating the panel and cured film thereon.

FIG. 16 is another schematic illustration of the second representative system for forming protective coatings on substrate surfaces, depicting subsequent shipping or storage of the protected panels.

FIG. 17 is a schematic illustration of a third representative system for forming protecting coatings on substrate surfaces, in accordance with a preferred embodiment of the present invention.

### DETAILED DESCRIPTION OF THE EMBODIMENTS

The present invention relates to protecting surfaces such as finished surfaces of consumer appliances, by providing a flexible, peelable, protective solid film on the surfaces of interest. The films can be easily removed at a later time by simply peeling the film from the surface. In accordance with the invention, a liquid curable resin composition is applied onto the surface of interest to form a thin layer or coating. The composition can be applied in any pattern or shape as desired. The coating is then cured to form the flexible, peelable, protective solid film. Each of these various aspects and details associated therewith are described in greater detail herein.

### Composition

The liquid curable resin composition comprises (i) one or more urethane acrylate oligomer(s), (ii) one or more acrylate monomer(s), and (iii) one or more photopolymerization initiator(s). The composition may also comprise one or more additives, agents, and other components.

The urethane acrylate oligomer(s) preferably constitute from about 10% to about 50% (all percentages expressed herein are percentages by weight unless indicated otherwise) of the composition. In certain applications, the amount of the urethane acrylate oligomer can be higher than 50%, such as up to about 68% or higher. The urethane acrylate oligomer is typically a reaction product of an isocyanate component and an acrylate or acrylate precursor. The isocryanate component preferably includes at least two reactive isocyanate functional groups. A wide array of aromatic and aliphatic isocyanates may be used. The acrylate or acrylate precursor is preferably reactive with the isocyanate component to form the urethane acrylate oligomer. Non-limiting examples of the acrylate include hydroxyl-functionalized acrylates, amine-functional acrylates, and combinations thereof. Preferably, the urethane acrylate oligomer is an aliphatic urethane acrylate having a functionality of two, and hence a diacrylate. An example of a commercially available aliphatic urethane diacrylate is available from Cytec Surface Specialties, Inc. of Smyrna, Ga. under the designation Ebecryl 8411.

The acrylate monomers preferably constitute from about 15% to about 40% of the composition. Lesser amounts may, in certain applications be used, such as from about 12% or 14%. The acrylate monomers may include a wide range of acrylate monomers such as a blend of monofunctional acrylate monomers, isobornyl acrylate (also known as isobornyl acrylate IBOA) and cyclic trimethylpropane formal acrylate. Isobornyl acrylate is commercially available from suppliers such as Sartomer Company, Inc. of Exton, Pa. under the designation SR506D or from Cytec under the designation Ebecryl IBOA. Preferably for most applications, isobornyl acrylate (IBOA) is used exclusively rather than the noted blend. In certain applications, it may be preferred to include one or more silicone acrylates. Typically, such silicone acrylates are included in an amount of from about 0.25% to about 4% of the composition. These silicone acrylates serve as flow and air release additives.

A particularly preferred composition is a 60/30 blend of (i) aliphatic urethane acrylated oligomer from Sartomer Company under the designation CN996J75, and (ii) a monofunctional monomer such as IBOA.

One or more polymerization initiators are also included in a range of from about 0.5% to about 8% of the composition. These initiators are preferably free radical initiators and most preferably photoinitiators, and initiate polymerization in the composition upon exposure to light, preferably light in the ultraviolet wavelength range, and most preferably in a wavelength range of from about 280 nm to about 420 nm, and more preferably from about 320 nm to about 410 nm. A preferred commercially available photoinitiator is Longcure 73 available from Lintech International or Darocur 1173 by Ciba of Basel, Switzerland. This photoinitiator is 2-hydroxy-2methyl-pentyl-propan-lone. It may also be preferred to use a blend of Longcure 73 and Benzophenone in a weight ratio of about 90/10, respectively. It is also contemplated that a photoinitiator combination of benzophenone or a benzophenone derivative and Longcure 73 could be used, such as for example in a weight ratio of benzophenone to Longcure 73 of from 1:3 to 1:1. This particular combination of photoinitiators does not require the use of nitrogen or an LED lamp. Additional preferred photoinitiators include, but are not limited to, phosphine oxide alpha-hydroxy ketone; benzophenone/Bistrimethyl-benzoyl phenyl-phosphine oxide/hydroxycyclohaxyl-phenyl-ketone; benzyl dimethyl ketal; and combinations thereof. Yet another preferred photoinitiator is ESACURE KB1 available from Lamberti of Gallarate, Italy. For certain applications, it is preferred to use a blend of photoinitiators such as ESACURE KT046 (phosphine oxide alpha-hydroxy ketone and benzophenone) from Lamberti/Sartomer, Irgacure 184 (hydroxycyclohexyl-phenyl-ketone) and Irgacure 819 (bis trimethyl benzoyl phenylphosphine oxide) from Ciba.

One or more additional components may also be included in the composition. Examples of such additional components include, but are not limited to flow promoting agents such as FM7725, a silicone oil available from Chisso North America of Rye, N.Y. and air release additives or defoamers such as Foamex N available from Evonik Degussa North America. Foamex N is a dimethyl polysiloxane with fumed silica by Tego®. It is also contemplated that various UV stabilizers could be utilized such as one or more polyol acrylates. A preferred UV stabilizer is commercially available under the designation FLORSTAB UV-2 from Kromachem. In addition, depending upon system and application demands, it may be preferred to use one or more additives to adjust surface tension. An additive for reducing surface tension is a polyether modified polydimethylsiloxane. It is also contemplated that various coloring additives can be used such as blue tint.

It is also contemplated that in applications in which release characteristics are to be improved, one or more release agents could be used in the composition. Non-limiting examples of release agents include reactive silicones such as those available under the designations BYK UV3510 and BYK 307 from BYK Chemie GmbH of Wallingford, Conn.

The composition is preferably prepared by mixing the urethane acrylate oligomer(s) and acrylic monomer(s) first, and then adding the additives or other agents as may be appropriate. The photoinitiator is then added. Preferably, mixing or blending is performed for about 30 minutes. The composition may also be prepared by mixing the monomer(s), oligomer(s), and initiator together. Although not wishing to be bound to any particular time period, it is believed that the uncured composition after mixing, has a shelf life of up to about six months.

### Application of Composition

The composition can be applied to the surface(s) of interest in nearly any manner. A preferred technique for applying the liquid composition onto the surface of interest is by screen printing.

Screen printing is a printing technique that uses a woven mesh to support a liquid-blocking stencil. The attached stencil forms open areas of mesh that transfer the liquid as a sharp-edged image onto a substrate. A roller or squeegee is moved across the screen stencil, forcing or pumping the liquid past the threads or strands of the woven mesh in the open areas.

A screen is generally a piece of porous, finely woven fabric called mesh stretched over a frame of aluminum or wood. Currently most mesh is formed from materials such as steel, nylon, and polyester. Areas of the screen are blocked off with a non-permeable material to form a stencil, which is a negative of the image to be printed; that is, the open spaces are where the liquid will appear.

The screen is placed atop a substrate. The liquid is placed on top of the screen, and a fill bar (also known as a flood bar) is used to fill the mesh openings with the liquid. The operator begins with the fill bar at the rear of the screen and behind a reservoir of the liquid. The operator lifts the screen to prevent contact with the substrate and then using a slight amount of downward force moves the fill bar to the front of the screen. This effectively fills the mesh openings with the liquid and moves the liquid reservoir to the front of the screen. The operator then uses a squeegee (rubber blade) to move the mesh down to the substrate and pushes the squeegee to the rear of the screen. The liquid that is in the mesh opening is pumped or squeezed by capillary action to the substrate in a controlled and prescribed amount, i.e. the wet liquid deposit corresponds to the thickness of the mesh and or stencil. As the squeegee moves toward the rear of the screen the tension of the mesh pulls the mesh up away from the substrate (called snap-off) leaving the liquid upon the substrate surface.

Although screen printing is described herein as a preferred technique, it will be understood that other techniques may be used for applying or depositing the liquid composition onto the surfaces of interest. Non-limiting examples of other techniques include dipping spray coating, pouring, wiping, brushing, ink jet printing, roll coating and/or any technique whereby a liquid is applied onto a receiving surface.

When using a screen printing technique to apply the liquid composition onto the surface of interest, it has been found that a screen mesh of about 83 to about 140 provides excellent results. Screen printing is preferably performed using a urethane base squeegee having a hardness of from about 30 to about 70 Shore A durometer hardness. The screen material is preferably polyester or stainless steel. It will be understood however, that in no way is the present invention limited to the use of such screens.

Regardless of the manner by which the composition is applied onto the surface of interest, it is preferred that the resulting coating or layer has a thickness of from about 0.90 to about 1.75 mils, more preferably from about 1.0 to about 1.50 mils, and most preferably from about 1.10 to about 1.40 mils.

### Curing

After application of the liquid composition onto the surface(s) of interest, and preferably to the noted desired thickness, the resulting coating is then cured. References to the composition being “cured” or undergoing “curing” refer to the monomers and oligomers in the composition undergoing polymerization and crosslinking. Preferably, curing is accomplished by exposing the coating to ultraviolet light, and most preferably to light having a wavelength in the range of from about 280 to about 420 nm for a period of time sufficient to cure the composition.

Although not wishing to be limited to any particular curing technique, it has been found that curing by use of medium pressure mercury vapor incandescent bulbs, optionally used in association with light emitting diode (LED) lights emitting light in the ultraviolet range, provides excellent results. For example, in one preferred curing technique, curing is achieved using a combination of medium pressure mercury vapor bulbs operating at 300 watts and curing of the coating occurring in an inert or non-oxidizing atmosphere such as in a blanket of nitrogen gas. In another preferring curing technique, curing is achieved using a combination of medium pressure mercury vapor bulbs at 300 watts and one or more LED's outputting light at a wavelength of either 365 nm or 395 nm. In either of these techniques, cure time is primarily dependent upon the number of mercury vapor bulbs, and thus upon the total power or wattage of light output. Most preferably, a light output level of at least 1000 mJ/cm² is preferred. Curing may be performed using an inert atmosphere such as a nitrogen blanket. In other applications, curing may occur while exposed to air.

### Protective Film

The film resulting after curing of the composition is flexible, exhibits relatively high strength properties, and can be readily peeled from the underlying surface. The ability of the film to be readily peeled from the surface depends upon an array of factors. Generally however, the film must exhibit sufficient strength and tear resistance so that it will not rip or sever upon its removal from the surface. The film must also exhibit sufficient adhesion to the surface to remain adhered thereto during the times at which the film is to provide protection to the surface, yet not be so securely adhered to the surface that the film is difficult to remove, or cause the film to rip or tear during removal. The film must also exhibit sufficient resistance to lubricants as are typically encountered in a manufacturing environment. And, the film must also exhibit appropriate properties upon application of compressive loading, such as when various panels containing one or more films are stacked upon one another in warehouses or other inventory storage facilities.

Preferably, the resulting cured film exhibits an adhesion to the surface of from about 30 to about 300 grams per inch, when measured with a peel force gauge. An example of such measurement is described herein.

Preferably, the resulting cured film exhibits a strength, which when measured with a peel force gauge, is from about 800 to about 2400 grams, without breaking. The strength of the film can be adjusted by varying the degree of cure and the film thickness.

Preferably, the resulting cured film exhibits properties such that films will not degrade thereby losing structural integrity upon exposure to lubricants for an extended period of time, such as for about four (4) hours. Also, it is preferred that the resulting cured film be resistant to coloration or other staining from the lubricant under consideration. And, it is also preferred that the cured film prevent passage of the lubricant to the underlying substrate at which detrimental staining could also occur. The present invention films exhibit these properties. An example of a testing procedure for this is described herein.

Preferably, the resulting cured film exhibits properties so that coated substrates containing the film(s), can be stacked or otherwise placed in contact with one another without detrimental interaction between the film(s). This characteristic is particularly desirable at elevated temperatures because coated panels are typically stacked in warehouses or semi-truck trailers in which temperatures can reach 150° F. The present invention films exhibit these properties. An example of a testing procedure for this is described herein.

The resulting film can be formed or otherwise subjected to one or more additional operations or may include agents, to impart a colored appearance or other aesthetic aspect(s) to the film. For example, the film can be transparent, translucent, or opaque. The film may be colored or tinted in nearly any color such as blue, red or violet.

Most preferably, the film is free of any polyvinyl chloride components, contains no hazardous air pollutants (HAP), and contains less than 0.5% volatile organic components (VOC's). These characteristics enable the film to be recycled, disposed, or otherwise processed without the attendant problems associated with prior art films. Moreover, it is preferred that the protective film is free of any phthalates.

### Substrates

The present invention can be used in conjunction with a variety of substrates and surfaces. As noted, finished, i.e. painted or coated, metal panels such as used in consumer appliances are particularly well suited for the present invention. Non-limiting examples of such appliances include refrigerators, freezers, clothes washers, clothes dryers, ranges, stoves, thermal ovens, cook tops, microwave ovens, dishwashers, water heaters, trash compactors and air conditioners. Additional examples of substrates include but are not limited to wood, glass, painted surfaces, and plastic. It will be appreciated that the invention may be used in conjunction with nearly any substrate material. The substrates may be subjected to a variety of pretreatments prior to receiving the coatings described herein. For example, the substrates may receive one or more polyester or epoxy pretreatment coatings, which can include various additives and be partially or fully cured. The substrates may also be subjected to one or more pretreatment operations such as flame treatments to modify their surface characteristics.

### Preferred Methods of Applying Film

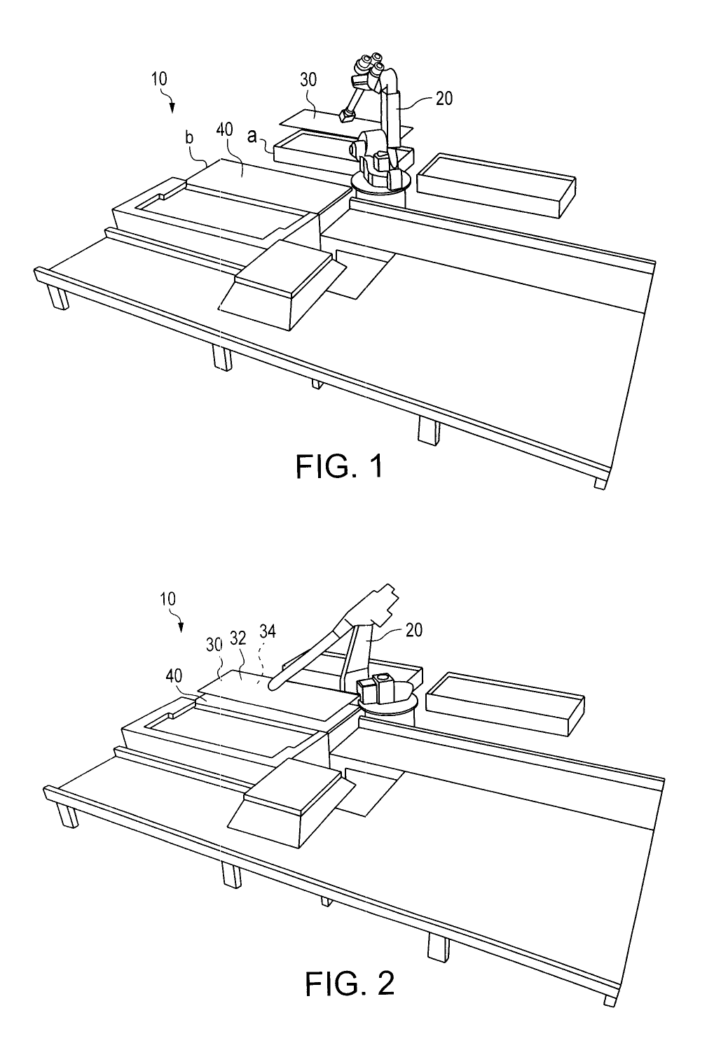

FIG. 1 illustrates a representative film forming assembly 10 for performing the present invention methods. The film forming assembly 10 generally comprises a robot 20 capable of transporting one or more panels 30 to be coated from a first location such as location a shown in FIG. 1 to a second location b, which may correspond to a staging area 40. A wide array of robots 20 or other mechanized assemblies can be used to transport the panels 30. However, it is preferred that the panels 30 be appropriately positioned in the staging area 40, as described herein.

Referring to FIG. 2, it is preferred that a face 32 of the panel 30 which is to be protected by a film in accordance with the invention, is directed upward when the panel 30 is placed in the staging area 40. The opposite face 34 of the panel will accordingly, be directed downward. It is also preferred that the panel 30 be appropriately aligned with an entrance of the next stage.

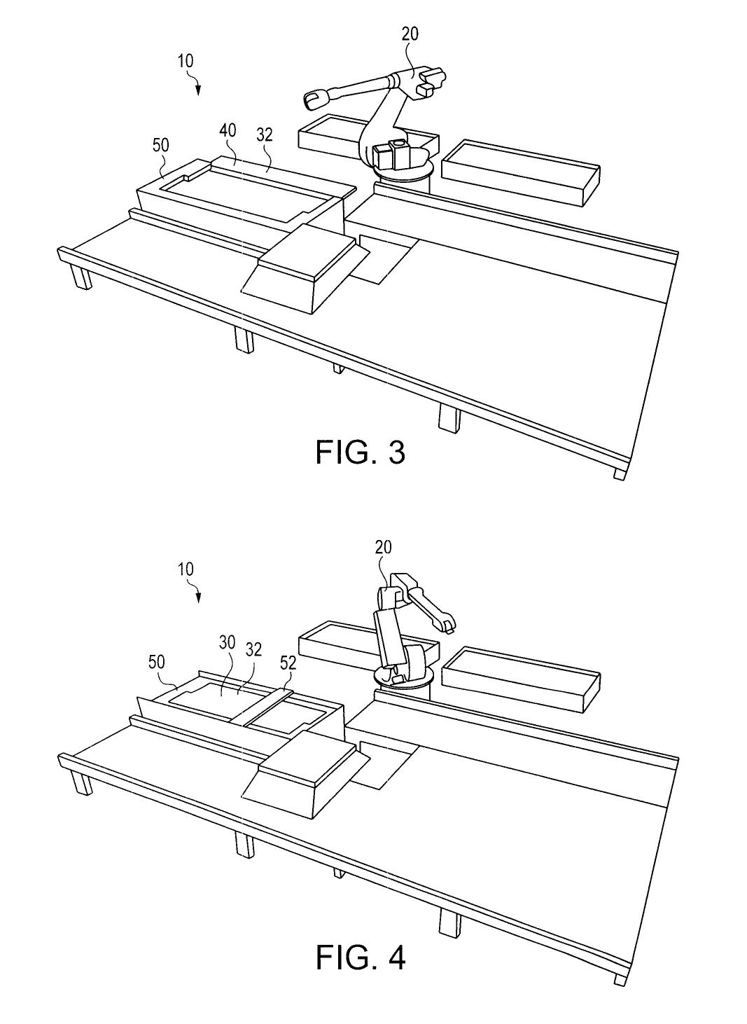

After appropriate positioning of the panel 30, the panel 30 is then transported from the staging area 40 to a screen printer 50, at which a liquid curable resin as described herein is applied to the face 32 of the panel 30. This operation is illustrated in FIG. 3.

FIG. 4 illustrates the panel 30 undergoing a screen printing operation in the screen printer 50. A squeegee 52 is moved across a screen to urge transfer of the liquid composition from the screen to the face 32 of the panel 30.

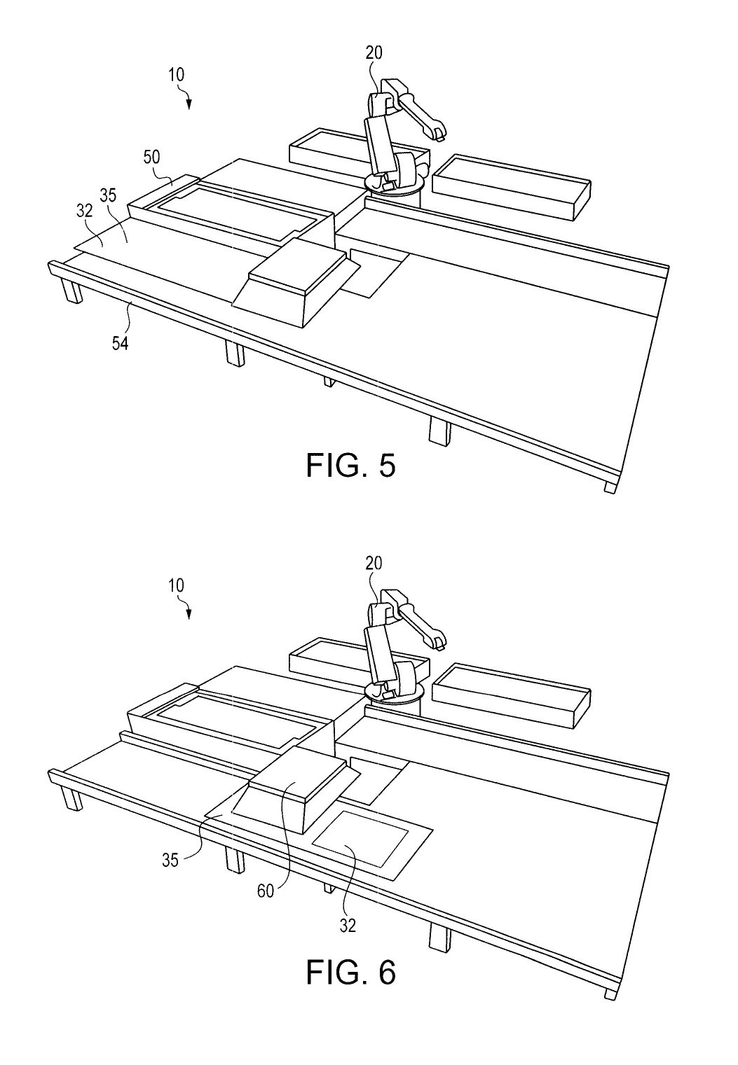

FIG. 5 illustrates the panel after screen printing, now designated as panel 35 containing a layer of the liquid composition on its face 32. The panel 35 can be transported to a second staging area 54 downstream of the screen printer 50.

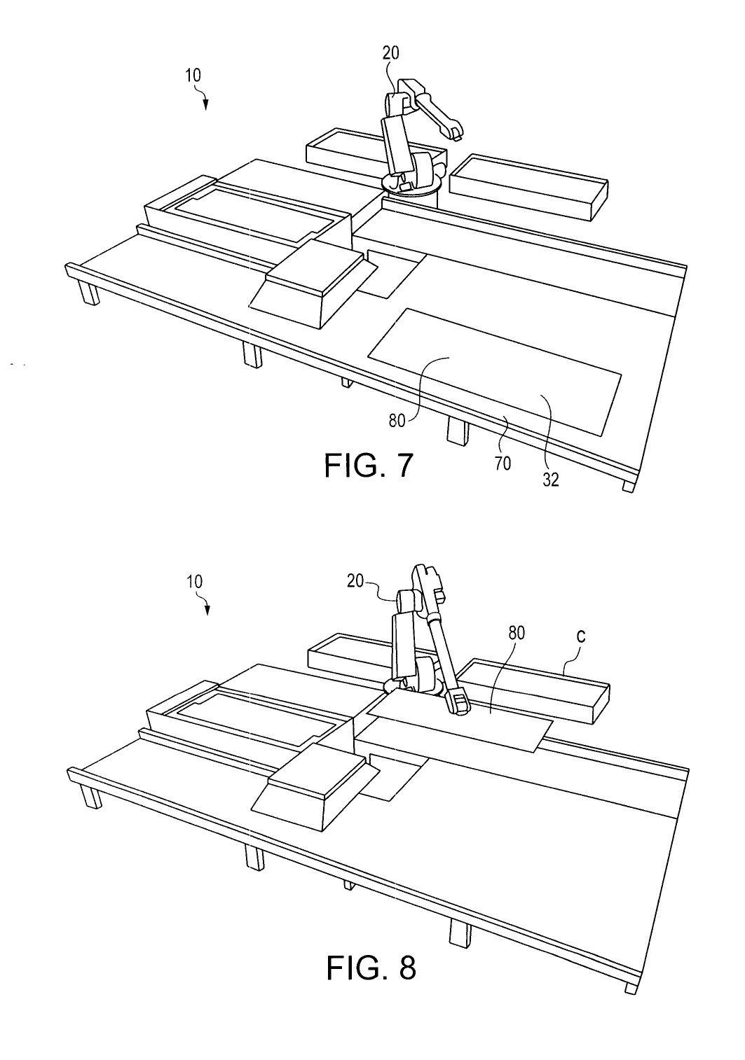

As shown in FIG. 6, the coated panel 35 is then directed or otherwise transported to a curing stage 60. As described herein, the curing stage 60 preferably emits ultraviolet light upon the face 32 of the panel containing the composition to be cured. Curing of the composition results in formation of the protective film. Curing of the composition into the film can occur in a batch fashion, a continuous fashion, or in a combination of these methodologies. In a batch cure, the panel would remain in the curing stage 60 until complete cure, or nearly complete cure, was achieved. A continuous process could be used in which the panels are slowly moved past the lamps emitting the ultraviolet light, whereby a desired residence time about 30 minutes would be achieved. Panels exiting the curing stage 60 are transported to a discharge area 70 depicted in FIG. 7.

Referring to FIG. 7, a panel 80 containing a cured film on its face 32 awaits further transport in the discharge area 70.

The robot 20 or other means can then transport the panel 80 to a desired location such as location c for finished protected product pickup, as shown in FIG. 8.

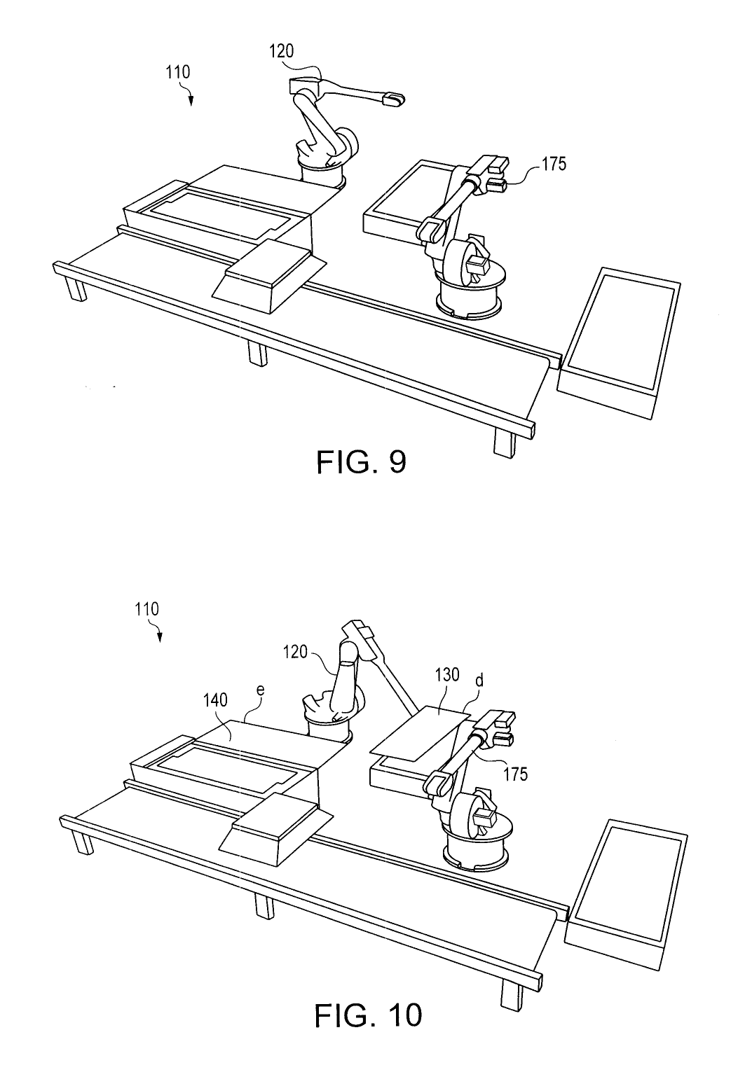

FIG. 9 illustrates another representative film forming assembly 110 for performing the present invention methods. The film forming assembly 110 comprises a first robot 120 and a second robot 175. Both robots 120, 175 are capable of transporting one or more panels. The second robot 175 is preferably located downstream from the first robot 120.

FIG. 10 illustrates the first robot 120 transporting a panel 130 to be coated from a first location d to a second location e, such as a staging area 140.

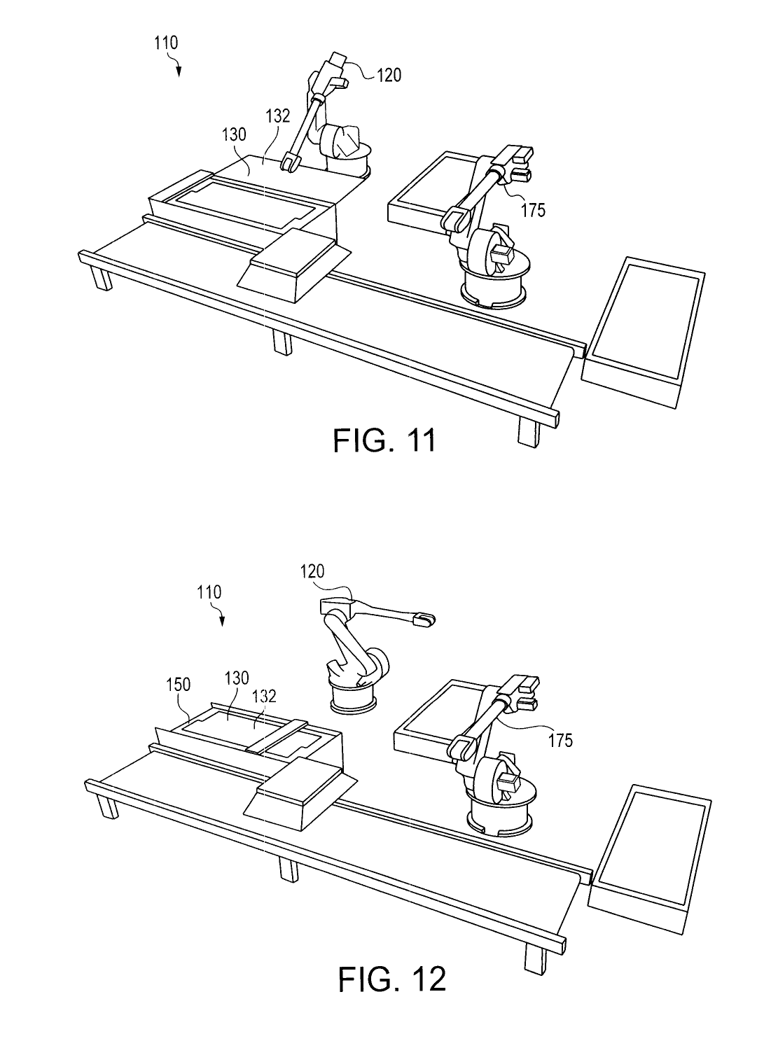

As shown in FIG. 11, the panel 130 is appropriately positioned such that its face 132 to be coated is directed upward prior to receiving the liquid composition.

After appropriate positioning of the panel 130, the panel 130 is then transported from the staging area 140 to a screen printer 150, at which a liquid curable resin as described herein is applied to the face 132 of the panel 130. This operation is illustrated in FIG. 12.

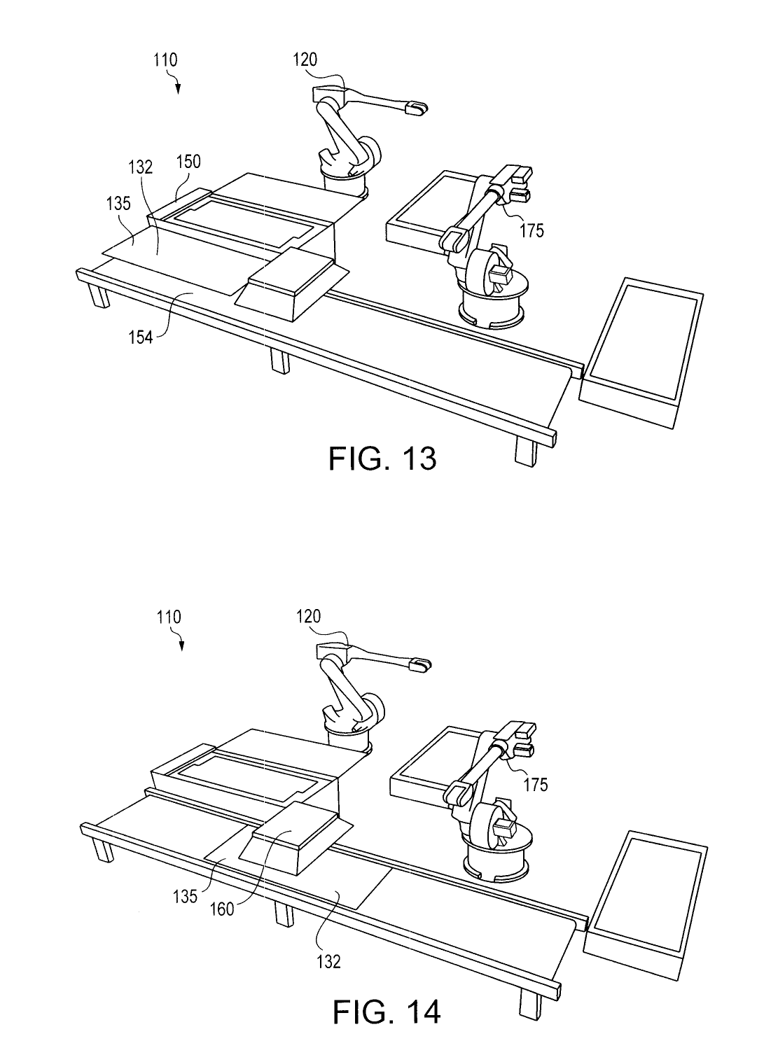

FIG. 13 illustrates the panel after screen printing, now designated as panel 135 containing a layer of the liquid composition on its face 132. The panel 135 can be transported to a second staging area 154 downstream of the screen printer 150.

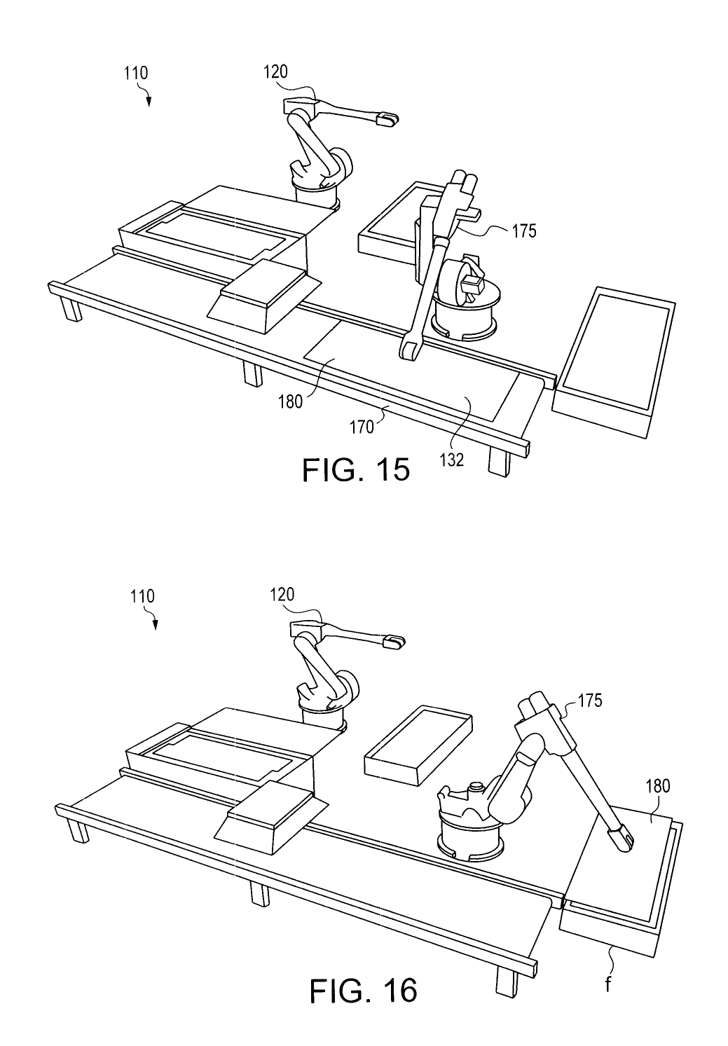

As shown in FIG. 14, the coated panel 135 is then directed or otherwise transported to a curing stage 160. As described herein, the curing stage 160 preferably emits ultraviolet light upon the face 132 of the panel containing the composition to be cured. Curing of the composition results in formation of the protective film. Curing of the composition into the film can occur in a batch fashion, a continuous fashion, or in a combination of these methodologies. In a batch cure, the panel would remain in the curing stage 160 until complete cure, or nearly complete cure, was achieved. A continuous process could be used in which the panels were slowly moved past the lamps emitting the UV light, whereby a desired residence time about 30 minutes would be achieved. Panels exiting the curing stage 160 are transported to a discharge area 170 depicted in FIG. 15.

Referring to FIG. 15, a panel 180 containing a cured film on its face 132 awaits further transport in the discharge area 170.

The second robot 175 or other means can then transport the panel 180 to a desired location such as location f for finished protected product pickup as shown in FIG. 16.

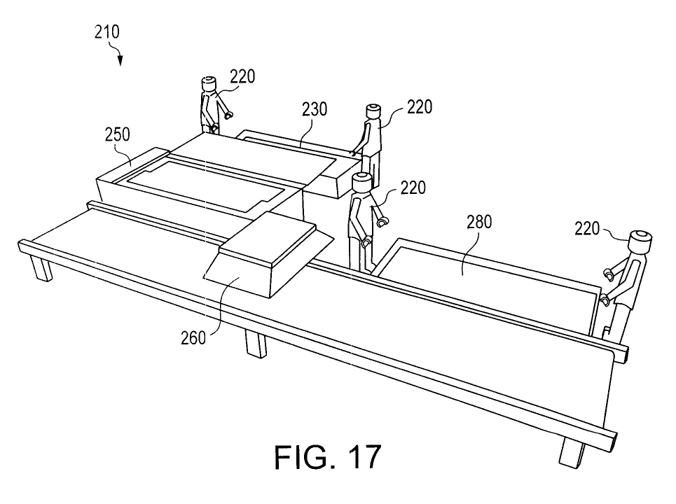

FIG. 17 illustrates another representative film forming assembly 210 for performing the present invention methods. Instead of using one or more robots, the assembly 210 utilizes one or more humans 220, primarily to transport panels 230 to be coated, and panels 280 after coating. The assembly 210 preferably includes a screen printer 250 and a curing stage 260.

### Methods of Protecting

Using the previously noted compositions and application techniques, the present invention provides methods of protecting surfaces of substrates. Generally, such methods comprise coating at least a portion of the surface of the substrate with a liquid curable resin composition as described herein. The method then involves exposing the coated portion of the substrate to an amount of ultraviolet radiation sufficient to cure the liquid composition and thereby form a flexible, protective solid film on the portion of the surface of the substrate. The method further comprises peeling the flexible, protective solid film from the portion of the surface of the substrate. The methods of the present invention provide protection to substrate surfaces, and particularly, even after such substrates have been bent or deformed. The ability of the protective film to remain adhered to the substrate even after bending is a significant advantage and is believed to provide an advance over currently known films.

Specifically, a feature of certain embodiment protective films is their ability to deform without tearing or rupturing. This feature is important as it allows the protective films to remain attached to an underlying substrate, while the substrate is subjected to one or more forming operations. For example, a metal substrate panel carrying a protective film on one or more of its faces can be subjected to an operation in which one or more raised or depressed regions are formed in the panel. The unique ability of the protective films to deform with the metal panel in the raised or depressed region, without tearing and while remaining with the panel, is remarkable. Although not wishing to be limited to any particular degree of deformation, many of the preferred embodiment films exhibit deformation extents of at least 10%, more preferably at least 15%, more preferably at least 20%, and most preferably at least 25%. The term “deformation extent” as used herein refers to the maximum increase in length of a sample of a protective film subjected to a tensile force prior to rupture, expressed as a percentage based upon the original length of the sample. An example of determining deformation extent is provided in the description of testing herein.

### Testing

### Film Release

The following procedure was performed to assess the adhesion of the film to a substrate surface. A liquid coating is applied to a substrate surface. The coating is then cured to form a cured film as described herein.

The film adhered to the substrate is then cut to form a collection of vertical strips, each approximately 1 inch wide, all strips being 6 inches in length. A horizontal marker line is noted along all strips, 4 inches from the bottom edge of the strips.

An Extech 47540 force gauge (or equivalent) is used to obtain release measurements. A horizontal pull tester assembly with clamps to secure the substrate and film is used. A speed control is also required. Clamps are used to secure the substrate and film strip(s).

The film is pulled from the top to the 4 inch mark so as to pull the film away from the substrate. The substrate is secured to the film release assembly. The loose end of the film strip is clipped or otherwise attached to the force gauge.

The speed of the pull is adjusted to 15, which corresponds to a speed of 8.180 mm/sec, and the film is pulled from the substrate until the film strip is completely removed from the substrate. The average force (in grams) as measured by the force gauge is recorded.

### Film Strength

Preferably, the film strength test can be performed after the noted film release test so that one or more 6 inch long strips of the film, removed from the substrate, can be subjected to strength testing.

One end of the film strip is attached to the previously noted film release assembly, and the other end of the film is attached to the force gauge without stretching the strip.

Next, the force gauge is zeroed or otherwise reset, and the assembly is activated so as to begin stretching the film strip. Stretching is continued until the strip fractures or rips into separate pieces. The average force (in grams) measured is recorded.

### Lubricant Resistance

This test can be used to determine the impact or effect of lubricants on the cured film. Lubricants are typically used in mechanical forming presses during preparation of panels. A primary concern involves what effects, if any, will the lubricant(s) have upon the films, and particularly whether the lubricants will migrate through the film thickness and/or degrade the film's structure or barrier characteristics.

A lubricant resistance test was performed upon a substrate coated with a preferred embodiment cured film as described herein. The test was performed as follows.

A sample of a lubricant(s) intended for use in the production environment is obtained. A substrate having a protective film on its face is provided. The film is divided into one or more test regions. A drop of each lubricant to be tested is placed in a test region. Four different lubricants designated as “LUB 1,” “LUB 2,” “LUB 3,” and LUB 4″ are undergoing testing.

Next, each drop of lubricant is then covered with a watch glass or other suitable transparent cover. The status and condition of the film is checked periodically, such as every 15 minutes for the first 60 minutes, and then every 30 minutes for 2 hours, and finally every 60 minutes until 240 minutes total time has passed.

After the testing period has expired, e.g. 240 minutes, the watch glass is removed from each sample drop. Observations are then made by comparing the observed sample and surrounding film and substrate, and assigning a value according to Table 1:

TABLE 1
Performance Scale for Lubricant Resistance Test

| | |
|---|---|
| 0 | No stain in tape or metal |
| 1 | Tape react or stain, but not pass to metal |
| 2 | Tape react to lube and pass to metal (small stain) |
| 3 | Tape react to lube and pass to metal (large stain) |

This test can be used to determine whether selected lubricant(s) are compatible with the film, or whether the film(s) are compatible with lubricants in use. The preferred embodiment cured films described herein typically exhibit a value of “0” for nearly all lubricants typically used in a metal enclosure panel production environment.

### Blocking

This test assesses the response of cured films to stacking and contact between one another, such as typically occurs during the production process and shipping process. In addition, this test also investigates behavior of the films, particularly in stacked contact with one another, at elevated temperatures. Coated panels or substrates are typically exposed to elevated temperatures in warehouses and shipping containers. Such elevated temperatures may be as high as 150° F.

This test is performed by cutting or otherwise forming 40 squares, each square having a size of 4 inches by 4 inches, from a panel coated with a protective film as described herein. This collection of 40 squares, each of the same 4 inch by 4 inch size, is obtained. This collection of 40 squares is designated as the control collection.

Next, each collection of squares is stacked to form two piles of squares. All test squares are placed in one stack. And all control squares are placed into another stack.

Within each stack, i.e. the test stack and the control stack, position adjacent squares so that contact occurs between (i) a film face of one square and a film face of an adjacent square, and (ii) a film face of one square and an uncoated face, i.e. a face without any film, of an adjacent square. Ideally, multiple occurrences of (i) and (ii) will exist in each of the test stack and the control stack.

Next, place the test stack in an oven or other temperature controlled chamber with a 50 pound weight on the top of the stack. The weighted assembly is then left in the oven at 150° F. for 24 hours.

The control stack is placed in an environment at ambient temperature, with a 50 pound weight placed on top of it. This weighted assembly is then left for 24 hours.

After 24 hours, the weights from both the stacks are removed and the faces of the individual squares are then inspected. Preferably, the squares in neither of the orientations (i) nor (ii), stick or otherwise adhere to one another. Accordingly, it is preferred that the squares all release from one another, without prying or applying excessive force. It is also preferred that all squares and all of their faces, i.e. coated and uncoated, are in good condition and that the film is not damaged or otherwise torn or removed from the panel.

### Deformation Extent

The deformation extent of film samples is determined by removing the film from a substrate, and cutting the film into strips. Although a wide array of sizes and proportions can be used for the strips, typically, strips are 1 inch wide by 6 inches in length. The film strips are then subjected to a tensile force in the length direction of the strips. The strips are pulled until complete rupture of the strip occurs. The length of each portion or fragment of the strip is totaled, and that total L_{f} is then compared to the initial length Lᵢ of the strip. The increase in length or deformation extent D, is calculated by (L_{f}−Lᵢ)/Lᵢ*100%.

In another series of investigations, several compositions in accordance with the invention were prepared and applied to various substrates. The compositions F1-F4 are set forth below in Tables 2 to 5 below.

TABLE 2
Representative Preferred Composition

| Company | F1 | | Category | Description |
|---|---|---|---|---|
| Sartomer | CN966J75 | 60.81 | OLIGOMER | Aliphatic urethane |
| | | | | diacrylate |
| Eternal Chemical | IBOA | 26.39 | MONOMER | Isobornyl acrylate |
| Chisso Corporation | FM-7725 | 0.55 | FLOW ADD | Polydimethylsiloxane |
| Evonik | FOAMEX-N | 1.03 | ADD, DEFOAMER | Polydimethylsiloxane with |
| | | | | silica |
| Kromachem | FLORSTAB UV-2 | 0.43 | ADD, UV | Polyol acrylate |
| | | | STABILIZER | |
| BYK Chemie | BYK-307 | 1.73 | ADD, Reduce | Polyether modified |
| | | | Surface tension | polydimethylsiloxane. |
| BYK Chemie | BYK-UV3510 | 0.86 | ADD | Polyether modified |
| | | | | polydimethylsiloxane. |
| Lintech | LONGCURE-73 or | 3.76 | PHOTOINITIATOR | 2hydroxy-2methyl-pentyl- |
| International/Ciba | DAROCURE1173 | | | propan-1one. |
| Kingchem | IBOA/ | 4.31 | PHOTOINITIATOR | Isobornyl acrylate |
| | Benzophenone | | BLEND | |
| | Heliogen Blue, | 0.13 | TINT | |
| | dispersant, IBOA | | | |

TABLE 3
Representative Preferred Composition

| Company | F2 Higher Adhesion | | Category | Description |
|---|---|---|---|---|
| Sartomer | CN966J75 | 60.81 | OLIGOMER | Aliphatic urethane |
| | | | | diacrylate |
| Eternal Chemical | IBOA | 27.23 | MONOMER | Isobornyl acrylate |
| Chisso Corporation | FM-7725 | 0.55 | FLOW ADD | Polydimethylsiloxane |
| Evonik | FOAMEX-N | 1.03 | ADD, DEFOAMER | Polydimethylsiloxane with |
| | | | | silica |
| Kromachem | UVSTAB-2 | 0.43 | ADD, UV | Polyol acrylate |
| | | | STABILIZER | |
| BYK Chemie | BYK-307 | 0.3 | ADD, Reduce | Polyether modified |
| | | | Surface tension | polydimethylsiloxane. |
| BYK Chemie | BYK-UV3510 | 0.15 | ADD | Polyether modified |
| | | | | polydimethylsiloxane. |
| Lintech International/ | LONGCURE-73 or | 4.86 | PHOTOINITIATOR | 2hydroxy-2methyl-pentyl- |
| Ciba | DAROCURE1173 | | | propan-1one. |
| Kingchem | IBOA/ | 4.51 | PHOTOINITIATOR | Isobornyl acrylate |
| | Benzophenone | | BLEND | |
| | Heliogen Blue, | 0.13 | TINT | |
| | dispersant, IBOA | | | |

TABLE 4
Representative Preferred Composition

| Company | F3 | | Category | Description |
|---|---|---|---|---|
| Sartomer | CN966J75 | 58.9 | OLIGOMER | Aliphatic urethane diacrylate |
| Eternal Chemical | IBOA | 21.61 | MONOMER | Isobornyl acrylate |
| Chisso Corporation | FM-7725 | 0.633 | FLOW ADD | Polydimethylsiloxane |
| Evonik | FOAMEX-N | 1.2 | ADD, DEFOAMER | Polydimethylsiloxane with |
| | | | | silica |
| Kromachem | UVSTAB 2 | 0.5 | ADD, UV STABILIZER | Polyol acrylate |
| Lintech | LONGCURE-73 or | 3 | PHOTOINITIATOR | 2hydroxy-2methyl-pentyl- |
| International/Ciba | DAROCURE1173 | | | propan-1one. |
| Kingchem | IBOA/ | 2 | PHOTOINITIATOR | Isobornyl acrylate |
| | Benzophenone | | BLEND | |
| Sartomer | IBOA/ESACURE | 12 | PHOTOINITIATOR | Benzyl Dimethyl Ketal |
| | KB1 | | BLEND | |
| | Heliogen Blue, | 0.15 | TINT | |
| | dispersant, IBOA | | | |

TABLE 5
Representative Preferred Composition

| Company | F4 | | Category | Description |
|---|---|---|---|---|
| Sartomer | CN966J75 | 65.94 | OLIGOMER | Aliphatic urethane diacrylate |
| Eternal Chemical | IBOA | 14.85 | MONOMER | Isobornyl acrylate |
| Chisso Corporation | FM-7725 | 0.70 | FLOW ADD | Polydimethylsiloxane |
| Evonik | FOAMEX-N | 1.32 | ADD, DEFOAMER | Polydimethylsiloxane with |
| | | | | silica |
| Kromachem | UVSTAB 2 | 0.55 | ADD, UV | Polyol acrylate |
| | | | STABILIZER | |
| Lintech International/ | LONGCURE-73 | 1.65 | PHOTOINITIATOR | 2hydroxy-2methyl-pentyl- |
| Ciba | | | | propan-1one. |
| Sartomer/Ciba | ESACURE | 1.65 | PHOTOINITIATOR | Phosphine oxide alpha- |
| | KT046/IRGACURE | | BLEND | hydroxy ketone and |
| | 819/IRGACURE 184 | | | benzophenone/Bistrimethyl- |
| | | | | benzoyl phenyl-phosphine |
| | | | | oxide/hydroxycyclohaxyl- |
| | | | | phenyl-ketone |
| Kingchem | IBOA/IRGACURE184 | 13.19 | PHOTOINITIATOR | Isobornyl acrylate |
| | | | BLEND | |
| | Heliogen Blue, | 0.16 | TINT | |
| | dispersant, IBOA | | | |

Various steel and aluminum substrates were subjected to several pretreatments and then coated with the compositions of Tables 2 to 5. The coated substrates are noted below in Table 6. The coated panels demonstrated excellent protective and retentive properties.

TABLE 6
Coated Substrates

| | | | Aluminum | | | | |
|---|---|---|---|---|---|---|---|
| | | | | | | | Precoated, |
| | Steel | | | Precoated | Precoated | Precoated | epoxy-flame |
| | Stainless | Stainless | Precoated | Polyester, | Polyester, | epoxy, fully | treated and |
| | 201 | 304 | Polyester | fully cured | slip additive | cured | fully cured |
| F1 | X | X | X | X | | X | X |
| F2 | X | X | X | X | | X | X |
| F3 | | X | | | X | | X |
| F4 | | X | | | X | | X |

Many other benefits will no doubt become apparent from future application and development of this technology.

All patents, published applications, and articles noted herein are hereby incorporated by reference in their entirety.

As described hereinabove, the present invention solves many problems associated with previous type methods. However, it will be appreciated that various changes in the details, materials and arrangements of parts and operations, which have been herein described and illustrated in order to explain the nature of the invention, may be made by those skilled in the art without departing from the principle and scope of the invention, as expressed in the appended claims.

What is claimed is:

1. A method for forming a flexible, peelable, protective solid film on a surface of a substrate, the method comprising the steps of:
coating at least a portion of the surface of the substrate with a liquid curable resin composition; and
exposing the coated portion of the substrate to an amount of ultraviolet radiation sufficient to cure the liquid composition and thereby form the flexible, peelable, protective solid film on the portion of the surface of the substrate.

2. The method according to claim 1 wherein the liquid curable resin composition comprises a mixture of a urethane diacrylate oligomer, an acrylate monomer and a photopolymerization initiator.

3. The method according to claim 1 wherein the coating and exposing steps are performed in a non-oxidizing atmosphere.

4. The method according to claim 1 wherein the coating step is performed by screen-printing the liquid curable resin composition onto the portion of the surface of the substrate.

5. The method according to claim 1 wherein the amount of ultraviolet radiation sufficient to cure the liquid composition is at least about 1000 mJ/cm².

6. The method according to claim 1 wherein the ultraviolet radiation is supplied, at least in part, by a mercury vapor incandescent bulb or a light emitting diode.

7. The method according to claim 1 wherein the substrate is a metal panel of a major appliance.

8. The method according to claim 7 wherein the major appliance is selected from the group consisting of refrigerators, freezers, clothes washers, clothes dryers, ranges, stoves, thermal ovens, cook tops, microwave ovens, dishwashers, water heaters, trash compactors and air conditioners.

9. The method according to claim 1 wherein the film exhibits a deformation extent of at least 10%.

10. The method according to claim 9 wherein the film exhibits a deformation extent of at least 25%.

11. A method of protecting a surface of a substrate, the method comprising the steps of:
coating at least a portion of the surface of the substrate with a liquid curable resin composition;
exposing the coated portion of the substrate to an amount of ultraviolet radiation sufficient to cure the liquid composition and thereby form a flexible, protective solid film on the portion of the surface of the substrate; and
peeling the flexible, protective solid film from the portion of the surface of the substrate.

12. The method according to claim 11 further comprising the step of bending the substrate after the exposing step and before the peeling step.

13. The method according to claim 11 wherein the liquid curable resin composition comprises a mixture of a urethane diacrylate oligomer, an acrylate monomer and a photopolymerization initiator.

14. The method according to claim 11 wherein the coating and exposing steps are performed in a non-oxidizing atmosphere.

15. The method according to claim 11 wherein the coating step is performed by screen-printing the liquid curable resin composition onto the portion of the surface of the substrate.

16. The method according to claim 11 wherein the amount of ultraviolet radiation sufficient to cure the liquid composition is at least about 1000 mJ/cm².

17. The method according to claim 11 wherein the ultraviolet radiation is supplied, at least in part, by a mercury vapor incandescent bulb or a light emitting diode.

18. The method according to claim 11 wherein the substrate is a metal panel of a major appliance.

19. The method according to claim 18 wherein the major appliance is selected from the group consisting of refrigerators, freezers, clothes washers, clothes dryers, ranges, stoves, thermal ovens, cook tops, microwave ovens, dishwashers, water heaters, trash compactors and air conditioners.

20. The method according to claim 11 wherein the film exhibits a deformation extent of at least 10%.

21. The method according to claim 20 wherein the film exhibits a deformation extent of at least 25%.
